(19) United States
(12) Patent Application Publication
(10) Pub. No.: US 2015/0232317 A1
(43) Pub. Date: Aug. 20, 2015

(54) DRAIN CLEARING DEVICE

(71) Applicant: DRAIN POP LLC, Happy Valley, OR (US)

(72) Inventors: Sean Michael Donohue, Happy Valley, OR (US); Robert Shawn Petersen, Happy Valley, OR (US)

(21) Appl. No.: 14/701,299

(22) Filed: Apr. 30, 2015

Related U.S. Application Data
(63) Continuation-in-part of application No. 14/029,636, filed on Sep. 17, 2013.

(51) Int. Cl. B67D 1/07; B08B 9/00; B08B 5/02

(52) U.S. Cl. CPC B67D 1/07; B08B 5/02; B08B 9/00

(57) ABSTRACT

The disclosed drain clearing devices have a housing that has a gas reservoir and a pressurization mechanism, such as hand pump and/or gas cartridge that compresses and/or maintains compressed gas in a gas reservoir. A nozzle and a pressure release actuator also attached to the housing. The pressure release actuator, when activated, causes compressed gas to be released from the gas reservoir through the nozzle and into a drain to clear an obstruction.

### RELATED APPLICATIONS

This application is a continuation-in-part of currently pending U.S. patent application Ser. No. 14/029,636 filed Sep. 17, 2013, the contents of which are hereby incorporated by reference.

### BACKGROUND

Beverage dispensing machines are commonplace in eateries, convenience stores, gas stations and many other locations that provide or sell beverages. Beverage dispensing machines have spillage drains that frequently clog from debris and beverage syrup build-up. Conventional machines also have a drip tray that is positioned below the spouts that dispense the beverage and that is positioned to catch overflow of the dispensed beverages and other debris. The beverage overflow has a high concentration of sugar and other ingredients that can agglomerate and solidify over time. The beverage ingredients, debris and a low flow rate through the beverage overflow drain can cause clogs to form in the drain lines.

Clogged drains need to be cleared in order for the beverage dispensing machine to function properly. Typically, unclogging the drains requires highly skilled plumbers or beverage dispensing machine technicians. The process of having a plumber or technician unclog beverage dispensing machine drains is expensive and time consuming, which significantly increases the overall operating costs for the beverage dispensing machine and decreases end-user satisfaction. Clogged drains can also be cleared by adding chemicals to the drains to break-up the obstructions and clear the drains. For example, hot water and bleach are sometimes used. The hot water and bleach can break up at least part of an obstruction, but frequently does not completely break up the obstruction, which leads to the obstruction reforming relatively soon after the initial attempt to clear the drain.

Other chemicals, conventional and eco-friendly, can be used to clear the drains. However, such chemicals, while liquids when used to clear the obstructions, can also later solidify further down the drain system in other undesirable locations, such as in the public sewer system and cause drain damage there. Therefore, the industry would benefit from an effective, cost-efficient, and eco-friendly drain clearing solution.

### DESCRIPTION OF DRAWINGS

FIG. 1 is a perspective view of an example drain clearing device.

FIG. 2 is a perspective view of another embodiment of an example drain clearing device.

FIG. 3 is a cross-sectional view of the drain clearing device of FIG. 1 taken along line 3-3.

FIG. 4 is a cross-sectional view of another embodiment of a drain clearing device.

FIG. 5 is a side view of an example drain clearing device interfacing with a drain.

FIGS. 6-8 are variations of nozzle designs for the drain clearing devices.

FIG. 9 is a side view of an example drain clearing device.

FIGS. 10-12 are example nozzle attachments to the drain clearing device.

### DETAILED DESCRIPTION

Example embodiments of the disclosed drain clearing device include a housing that contains a gas reservoir, a pressurization mechanism and a pressure release actuator. Gas in the gas reservoir is pressurized by the pressurization mechanism which can be driven by a hand pump or other pressurization mechanism. A nozzle is attached to the housing and creates a seal with a drain. Upon actuation, the pressure release actuator causes the pressurized air in the gas reservoir to be released through the nozzle and forced into the drain. The release of the pressurized air increases the air pressure in the drain and exerts a force on any obstruction(s) blocking the drain, which causes the obstruction(s) to be dislodged or broken into smaller pieces and pushed through the drain to clear it.

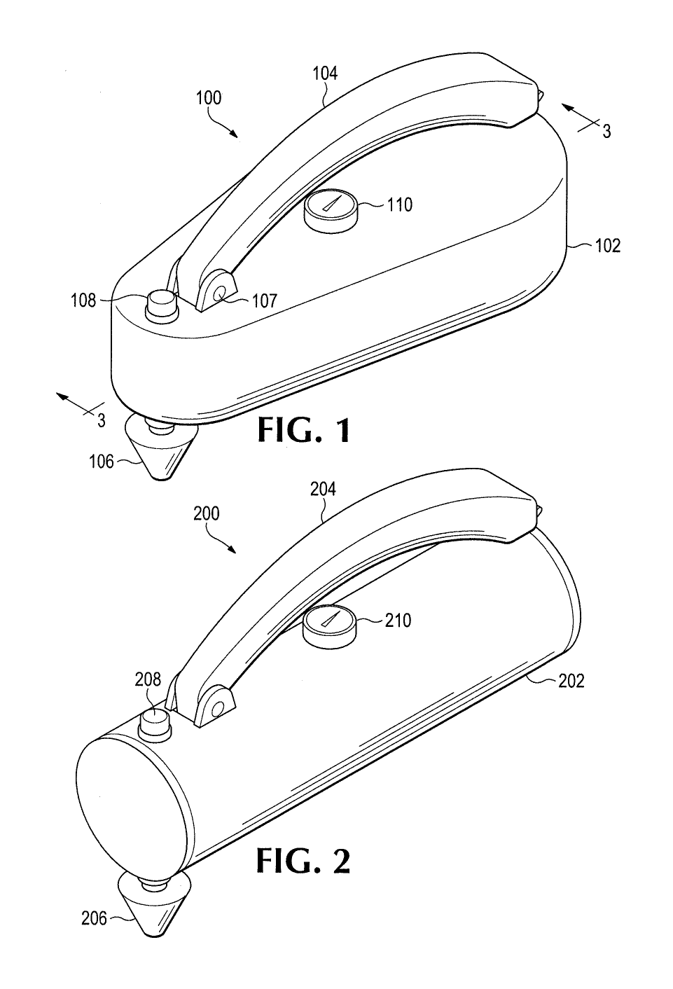

FIG. 1 is a perspective view of an example drain clearing device 100. The drain clearing device 100 includes a housing 102 that contains a pressurization mechanism, a gas reservoir and a gas release actuator (not shown). The housing 102 can be shaped in a compact, ergonomic shape for user comfort and configured to fit in the working environment around the drain, as shown in FIG. 1. Other suitable forms of the housing can be used. A user can pressurize gas in the gas reservoir with the pressurization mechanism.

An example pressurization mechanism is shown in FIG. 1 and is actuated by raising and lowering a handle 104 of the example drain clearing device 100. The handle 104 is attached to the housing 102 at a hinge 107 that permits the user to raise and lower the handle 104 to pressurize the gas reservoir. A nozzle 106 is releasably attached to the housing 102 at a point opposite the handle, or other desirable location. The nozzle 106 can be of various configurations that interface with a variety of drain designs and types. The nozzle 106 is in fluid communication with the gas reservoir so that the pressurized gas can flow from the gas reservoir to the nozzle 106.

A pressure release button 108 initiates the release of pressurized gas from the gas reservoir to the nozzle 106. Other suitable pressure release actuators can be used to initiate the pressurized gas flow from the gas reservoir to the nozzle. The user can actuate the pressure release button 108, which causes at least a portion of the pressurized air to be released from the gas reservoir, out through the nozzle 106 and into the drain. A pressure gauge 110 located on the housing 102 displays the stored pressure within the gas reservoir, displaying to the user when the desired gas pressure for the stored gas in the gas reservoir has been achieved to clear the drain obstruction(s). In other embodiments of the drain clearing device the pressure gauge can be an indicator that desired pressure is reached or can be absent from the device.

FIG. 2 is another embodiment of a drain clearing device 200 having a different housing 202 configuration than that of the drain clearing device 100 of FIG. 1. The housing 202 is cylindrically shaped and the handle 204, pressure release mechanism 206, and pressure gauge 210 are located atop the housing 202, similar to the example drain clearing device shown in FIG. 1. Alternatively the device elements can be located elsewhere on the housing 202 as desired. A nozzle 208 is attached to the housing 202 and is located opposite the pressure release button 206, similar to the example drain clearing device shown in FIG. 1.

It is understood that the housing of the disclosed drain clearing devices can be of any desired design and configuration. The housing design can be tailored to fit in the working environment in which the drain clearing device is to be used. The housing design can also take into consideration user comfort and device stability during actuation of the handle to pressurize the gas reservoir. The housing may be a molded singular piece within which the internal components can be sealed to prevent moisture intrusion and premature wear and corrosion to the internal components. A molded single piece housing configuration has few seams and can be easily cleaned and maintained.

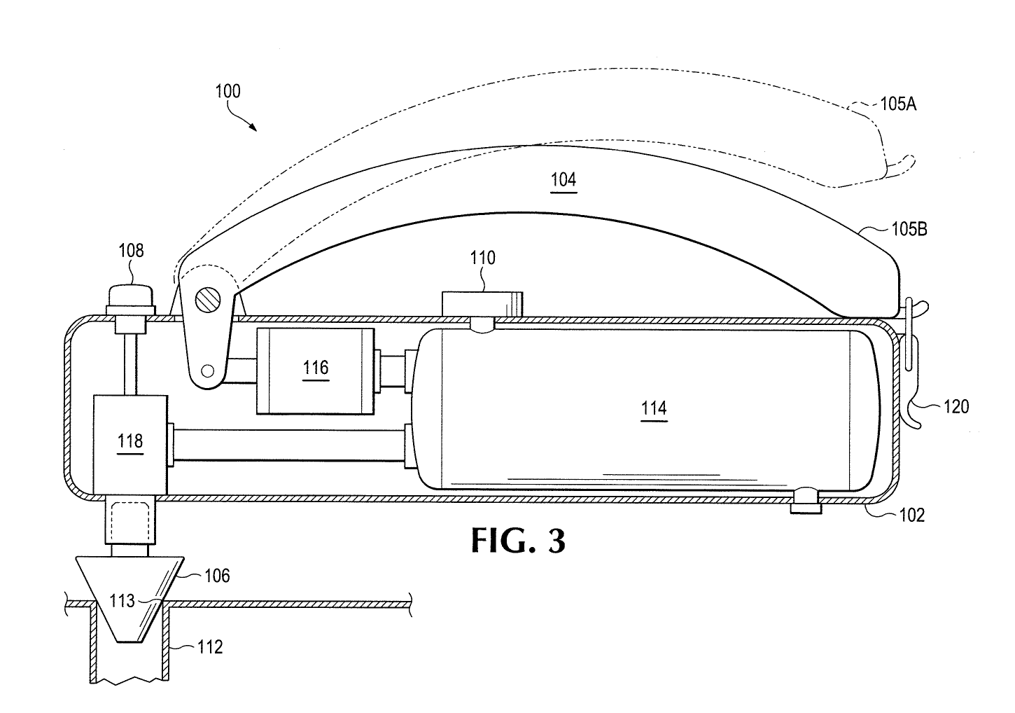

FIG. 3 is a cross sectional view taken along line 3-3 of the drain clearing device shown in FIG. 1. A gas reservoir 114, a gas compressor 116, and a pressure release actuator 118 are positioned within the housing 102 of the drain clearing device 100. The handle 104 is moved between a first position 105A and a second position 105B to drive the gas compressor 116 in a horizontal motion toward and away from the gas reservoir 114. In the example shown, the gas compressor 116 is aligned in a horizontal plane with respect to the gas reservoir 114. The compressor 116 compresses gas into the gas reservoir 114, on both the up and the down stroke of the handle 104. The gauge 110 indicates the pressure of the gas stored in the gas reservoir 114.

The nozzle 106 of the drain clearing device 100 is inserted into a drain opening 113 of the drain 112 to form at least a partial seal between the nozzle 106 and the drain opening 113. The nozzle 106, as shown in FIG. 3, is cone-shaped, with the tapered end extending through the drain opening 113 and into the drain 112. The nozzle 106 can be other suitable shapes and can also be customized to complement a particular drain to best create a seal between the nozzle and the drain opening.

In the example shown in FIG. 3, when the gas pressure in the reservoir 114 has reached a desired level, which can be indicated by a display such as a pressure gauge 110, the pressurized gas release is triggered. To initiate the pressurized gas release, the user actuates the actuator button 108, which causes the pressure release actuator 118 to release pressurized gas from the gas reservoir 114 through the nozzle 106 and into the drain 112. The compressed gas is forced through the drain 112 with enough force so that when it encounters an obstruction(s) it either pushes the obstruction(s) through the drain or breaks the obstruction(s) into smaller pieces that can then be moved through the drain.

Referring again to the drain clearing device shown in FIG. 3, a latch 120 is attached to the housing 102 and secures the handle 104 to the housing 102 when the user is not actively actuating the handle 104. In other embodiments of the example drain clearing device the latch 120 can be absent.

The gas reservoir of the drain clearing device stores the pressurized gas. The drain clearing device also may include a pressure relief valve that prevents over-pressurization of the gas reservoir. The pressure relief valve can be set to release gas from the gas reservoir at a preset pressure threshold. The gas reservoir has a maximum pressure it can contain. The pressure relief valve is preset to release at least some of the stored gas or otherwise prevent the gas pressure within the gas reservoir from exceeding the maximum pressure. In some examples, the pressure relief valve can be set to release at least a portion of the stored gas at a pressure lower than the maximum pressure. The pressure at which the pressure relief valve releases stored gas or otherwise reduces the gas pressure can be set by the manufacturer of the drain clearing device or by the user and may be changeable by the user or may be permanently set, as desired.

The pressure gauge 110 on the housing 102 indicates the pressure of the gas stored in the gas reservoir 114. The pressure gauge 110 has an indicator that displays to the user when the desired gas pressure to clear the drain is reached. The pressure to clean beverage dispensing machine drains can be between 80-130 psi, but higher or lower pressures may be used to achieve drain clearing at the discretion of the user.

The gas used to compress gas in the gas reservoir of the drain clearing device can be any number of gases or a combination of gases, including atmospheric air, CO₂, N₂, NO₂ and others. For example, the gas reservoir of the example drain clearing device can be pressurized using a compressed CO₂ tank. The compressed CO₂ tank may be pressed or attached to the drain clearing device against the nozzle on the housing, or other suitable location, to transfer CO₂ from the compressed CO₂ tank into the gas reservoir until the desired gas reservoir pressure is reached. The CO₂ tank could be used with a hand pump to pressurize the gas reservoir. In this example, the user also could pump the handle to add atmospheric air to the pressure applied to the CO₂ tank to further increase the stored pressure in the gas reservoir.

Another pressurized gas source that could be used in the drain clearing device is NO₂ cartridges or other containers. NO₂ cartridges can be used to pressurize the gas reservoir or can be inserted into the device to function as the compressed gas reservoir. Other pressurized gas containing cartridges can be used in a similar manner, such as CO₂ cartridges, with the cartridge inserted into the drain clearing device and functioning as the gas reservoir.

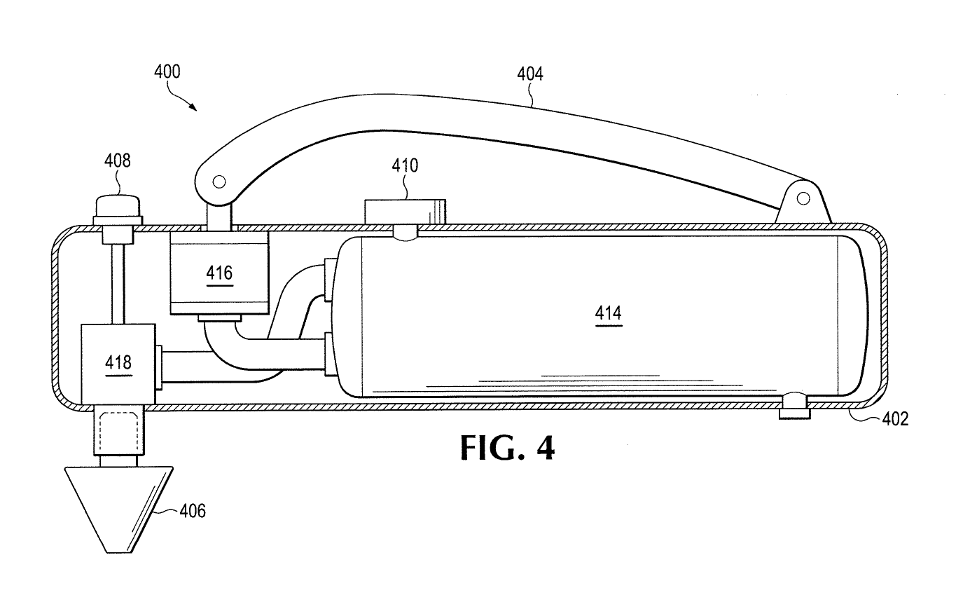

FIG. 4 is a cross sectional view of a drain clearing device 400 with a further embodiment of a gas reservoir 414, a gas compressor 416 and a pressure release actuator 418 within the housing 402. In this embodiment, the handle 404 drives the compressor unit 416 in a vertical manner with respect to the gas reservoir 414 rather than the horizontal manner as in the embodiment shown in FIG. 3. Gauge 410 displays the stored pressure of the gas in the gas reservoir 414. The actuator button 408 activates the pressure release mechanism 418, which initiates the flow of pressurized gas from the gas reservoir 414 through the nozzle 406.

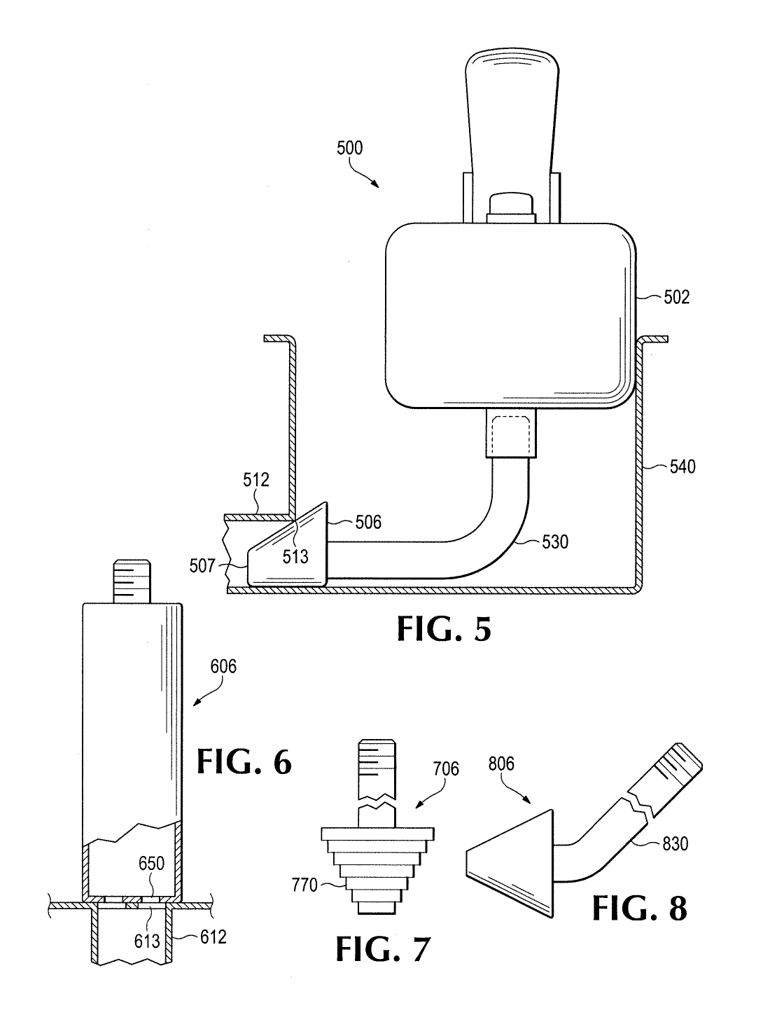

FIG. 5 shows an example drain clearing device 500 with the nozzle 506 forming a seal with a drain opening 513. Here, the nozzle 506 of the drain clearing device 500 is inserted in a drain opening 513 and extends into the drain 512 to form a seal between the nozzle 506 and the drain opening 513. The seal contains the pressurized gas exiting the nozzle 506 so the gas can be forced through the drain 512. In this example, the drain opening 513 is located in the drip pan 540 of a beverage dispensing machine. The drip pan 540 collects spillage of the dispensed beverages and debris and directs the spillage and debris into the drain opening 513. The nozzle 506 is cone-shaped and tapered towards an end 507. The tapered end 507 is inserted through the drain opening 513 and extends into the drain 512. The nozzle 506 provides a seal between the drain clearing device 500 and the drain 512, so that the drain clearing device 500 can direct pressurized gas from the gas reservoir into the drain 512 to clear an obstruction.

As shown in FIG. 5, the nozzle 506 is not connected directly to the housing 502 of the drain clearing device 500. Instead, an extension element 530 is disposed between the housing 502 and the nozzle 506. The extension element 530 is flexible and can be manipulated through the drip pan 540 to allow the user to insert the nozzle 506 into drains at varying angles with respect to the position of the drain clearing device 500. The extension element 530 also can be made of semi-flexible or even rigid material(s) in other examples. Example extension element materials include various rubber compounds, latex and some plastics. The flexibility of the extension elements allows the user to insert and seal the nozzle to the drain opening at various angles and in locations where the drain clearing device itself would not normally fit. The flexible extension element 530, as shown, is releasably connected to the housing 502 of the device 500 and the nozzle 506.

In other embodiments, the extension element can be made of a rigid material that would allow a user to reach a drain located in-line with the device exit port. The rigid extension element can provide enough support to allow a user to apply a force on the drain clearing device and thus the nozzle inserted in the drain to ensure a tight-fitting seal between the nozzle and the drain opening. The tight-fitting seal prevents leakage of the pressurized gas released from the interface between the nozzle and the drain opening. The extension elements, rigid or flexible, can be optionally used with any of the nozzles and can be removable from the drain clearing device entirely. The extension elements can have the same or a similar releasable connection to the housing as the nozzle does to the device and vice versa. A user can attach the extension element to the device and a nozzle to the extension element and then can insert the nozzle into the drain, which applies a force to form the seal between the nozzle and the drain opening. The user may use additional tools such as a mallet or other means to wedge the nozzle in place to achieve the desired seal between the nozzle and the drain clearing device.

The nozzle can be made of a semi-rigid material, such as a hard rubber that is typically used in test tube stoppers. The semi-rigid material of the nozzle can be pliable enough to deform and fit into the drain opening and rigid enough to exert sufficient circumferential pressure around the nozzle to hold it firmly in place within the drain opening. As discussed above, the semi-rigid nozzle helps create a seal between the nozzle and the drain opening to force the released pressurized gas into the drain, which dislodges or breaks up any obstructions, thus clearing the drain.

The nozzle can be releasably connected to the device housing. The nozzle connection to the housing may be done in multiple methods such as using any suitable mechanical connector. One example mechanical connector is a nozzle having a core that is threaded at an end protruding from the rubberized portion of the nozzle that is screwed into the housing. The threaded nozzle example is the embodiment shown in the figures. Another way to attach the nozzle to the housing is a quick coupler connector, such as those conventionally used in other air powered tools. The nozzle can be connected to the drain clearing device housing with any suitable releasable connection.

FIGS. 6-8 show example nozzles for the drain clearing devices. The example nozzles can be customized to complement the shape of a drain opening. Multiple nozzles can be attached and interchangeable with the same drain clearing device, in some examples. FIG. 6 is a cross-sectional view of an embodiment of a nozzle configured to interface with a drain opening that has a protective grating or other feature over the top of the opening that prevents a typical cone shaped nozzle from being inserted into the drain opening. The nozzle 606 is placed over the drain opening and grate to create a seal. The nozzle 606 has cut outs 650 that are disposed above the cut outs in the grate 613 of the drain 612. The nozzle cut outs 650 can extend into the drain in some examples and have a fitted collar that surrounds the adjacent area around the drain opening shown in FIG. 6.

FIG. 7 illustrates another nozzle design 706 that includes a semi-flexible material with a series of ridges 770 that create a seal with the interior surface of the drain. The ridges 770 allow the nozzle 706 to fit in a range of different drain diameters while maintaining the required force to create the necessary seal between the nozzle and the drain opening to force the compressed gas into the drain.

FIG. 8 is yet another variation in nozzle design. The nozzle 806 has an integrated, rigid extension element 830 in this example. The extension element could be any suitable material and could be a separate discrete element from the nozzle. The material could be a hard, rigid plastic or metal. The extension element allows the user to access drains that are at an angle with respect to the drain clearing device. The extension element 830 can sustain additional force on the nozzle 806 applied by the user to form a tight seal between the nozzle 806 and the drain.

To use the disclosed drain clearing devices, a user would first select a nozzle based on the configuration of the drain to be cleared, which may mean selecting the appropriate diameter and shaped nozzle and/or including the addition of an extension element between the nozzle and the drain clearing device in some examples. Gas is compressed into the gas reservoir, either by pumping a handle of a hand pump compressor or other compressing mechanism or from external sources as mentioned above. The gas reservoir can be pressurized before or after selecting the nozzle. When the gas reservoir is pressurized, or a pre-pressurized cartridge is inserted as mentioned above, the nozzle is placed into the opening of the drain, which forms a seal between the nozzle and the drain opening. Some or all of the compressed gas is released through the nozzle, for example, by actuating a pressure release button, which triggers the release mechanism to discharge gas from the gas reservoir and into the drain. The compressed gas is released and travels down the drain and eventually encounters any obstructions. The compressed gas contacts the obstructions and dislodges or breaks up the obstructions.

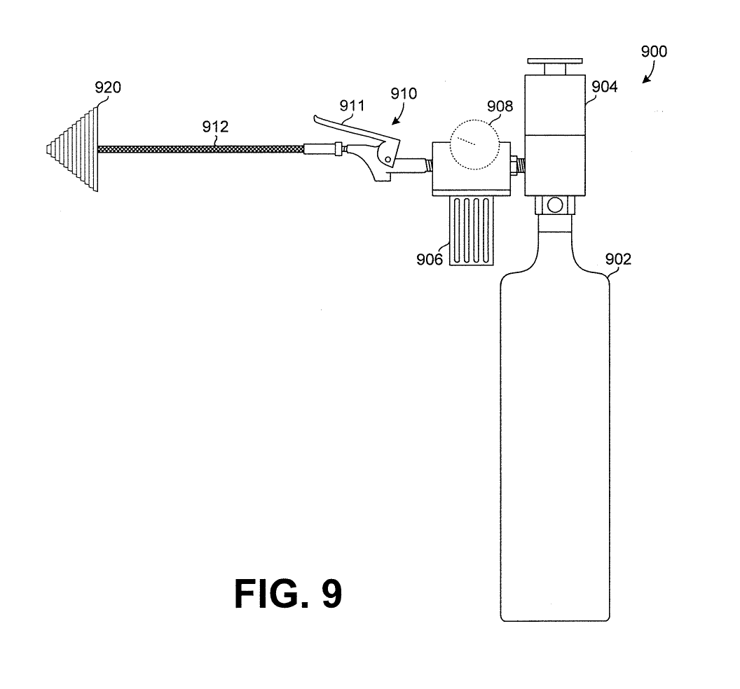

An alternative embodiment of the drain clearing device 900 is shown in FIG. 9. In this embodiment, the device 900 includes releasably connected device elements that deliver pressurized air into a drain to clear an obstruction(s). The modular design of this embodiment does not include a housing. Instead the device features exposed elements such as a gas reservoir 902, regulator 906 and triggering mechanism 910. The releasably interconnected device elements allow the device 900 to be decomposed into components that can be more easily carried and stored. Additionally, the modular nature allows the device elements to be easily changed depending on the drain, obstruction type, surrounding environment and other contributing factors.

FIG. 9 shows the alternative embodiment of the drain clearing device 900. A gas reservoir 902, containing pressurized gas, is releasably connected to and in fluid communication with a valve 904. The valve 904 can be actuated to control the flow of gas from the gas reservoir 902. A regulator 906 is releasably connected and in fluid communication with the valve 904. The regulator 906 controls the pressure of the gas released through the device 900. A pressure indicator 908 can also be disposed on the regulator to indicate the device 900 pressure to a user. A triggering mechanism 910 is releasably connected to and in fluid communication with the regulator 906. The triggering mechanism 910 is actuated by a user to cause the release of gas from the device 900. A flexible extension element 912 can be releasably connected to and in fluid communication with the triggering mechanism 910. The flexible extension element 912 allows the user to properly position a nozzle 920 in restricted areas where the complete device 900 may not fit. A nozzle 920 is releasably connected to and in fluid communication with the flexible extension element 912. The nozzle 920 interfaces with a drain opening, forming a seal and directing the pressurized gas into the drain. The pressurized gas introduced into the drain line by the device 900 contacts obstructions within the drain and clears them from the drain path.

The gas reservoir 902 of the device 900 is a pressure cylinder that contains the pressurized gas to be used in clearing the drain. In the example shown in FIG. 9, the gas reservoir 902 is a refillable aluminum container that can be detached from the device 900 and refilled with pressurized gas. Alternatively, the gas reservoir 902 can be a “one-time” use gas reservoir that is discarded once unusable. The gas used in the example device 900, as shown, is pressurized CO₂ having a pressure between 80 and 130 psi. Alternative pressurized gases can be used, such as pressurized atmospheric air, N₂ and NO₂.

The valve 904 is releasably connected to the gas reservoir 902 using a threaded connection as shown in the example device 900 of FIG. 9. The valve 902 can be actuated by a user to open or close, thus allowing or preventing the flow of the pressurized gas from the gas reservoir 902.

The regulator 906 releasably connected to the valve 902 using a threaded connection as shown in the example device 900 of FIG. 9. The regulator 906 regulates the pressure of the pressurized air flowing through the device 900. The pressure of the gas can be adjusted by a user by adjusting the regulator 906 to release air at a higher or lower pressure as desired. Allowing the regulation of the air pressure assists in ensuring that the drain line is not damaged by the introduction of pressurized air. Additionally, the regulation allows a user to incrementally increase the pressure applied to the obstruction.

The triggering mechanism 910 is releasably connected to the regulator 906. When actuated by a user, the triggering mechanism 910 allows the pressurized gas from the gas reservoir 902 to pass through and out of the device 900. The triggering mechanism 910, as shown in FIG. 9, has a handle 911, that when depressed triggers release of pressurized gas from the device 900. Alternatively, different triggering mechanisms, either mechanical or electromechanical, may be used to initiate the release of pressurized gas.

The flexible extension element 912 can be releasably connected to and disposed between the nozzle 920 and triggering mechanism 910. The use of the flexible extension element 912 allows the user to maneuver the nozzle 920 into position independently of the rest of the device 900. When confronted with confined areas around a drain opening, a user can use the flexible extension element 912 to place the nozzle 920 in the correct position within and ensure it is properly sealed against the drain opening. In the example device 900, as shown in FIG. 9, the flexible extension element 912 is vinyl tubing having a braided stainless steel outer covering. By employing the vinyl tubing and braided stainless steel cover, the flexible extension element 912, can be flexed into position and has the strength to contain the pressurized gas. The stainless steel covering also prevents undue flexing of the flexible extension element 912, which prevents the formation of kinks. Kinks can weaken the flexible extension element 912, which can lead to failure.

The nozzle 920 can be releasably connected to the flexible connection element 912, as shown in FIG. 9, or to the triggering mechanism 910 directly. The nozzle 920 is structured to interface with the opening of the drain to be pressed into place. The force pushing the nozzle 920 into the drain opening forms a seal about the periphery of the drain opening. The seal constrains the majority of the pressurized gas released by the device 900 within the drain. In the example shown in FIG. 9, the nozzle 920 features ridges, these ridges are formed at typical drain opening diameters. In doing so, the nozzle 920 can be used on a multitude of drain openings having differing opening diameters. A single nozzle 920 capable of being used on multiple drain opening diameters means the user changes the nozzle 920 less frequently, thus increasing the efficiency of the drain clearing process.

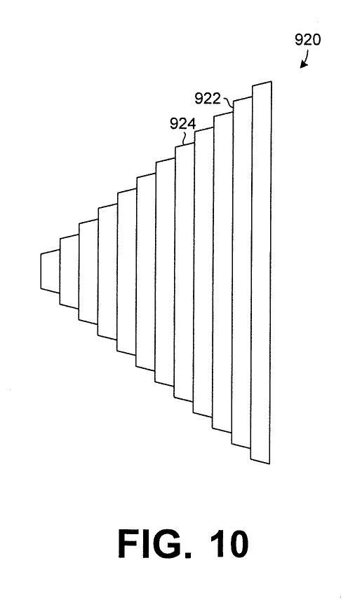

FIG. 10 is a detailed view of the nozzle 920. The nozzle 920 features a stair-step style pattern of sloped 924 and flat diameters 922. Layering the diameters 924 and 922 creates a universal nozzle 920 that can be used on a number of drains having different diameters. In the example embodiment shown, a midpoint on each of the sloped diameters 924 corresponds to the diameter of a different standard drain opening. When inserted into a drain opening, a sloped diameter 924 of the nozzle 920 contacts a circumference of the drain opening thereby forming a seal to contain and direct the pressurized gas from the device into the drain. Additionally, if the drain opening has a size not corresponding to a sloped diameter 924, the flat diameters 922 of the nozzle 920 can interface with the periphery about the drain opening to form the seal.

The nozzle 920 can be constructed of similar materials as discussed above in regards to alternative nozzle variations. In the embodiment shown in FIG. 10, the nozzle 920 is constructed of a silicon rubber. The silicon rubber material is conformable and flexible allowing the nozzle 920 to properly interface with the drain opening. Being composed of silicon and being flexible, the nozzle 920 has an inherent “tackiness” or “stickiness” about it, which assists in creating and maintaining the seal of the nozzle about the drain opening. Additionally, the silicon rubber is a non-toxic, non-reactive material that will not leave harmful residue behind once the nozzle 920 is removed from the drain opening.

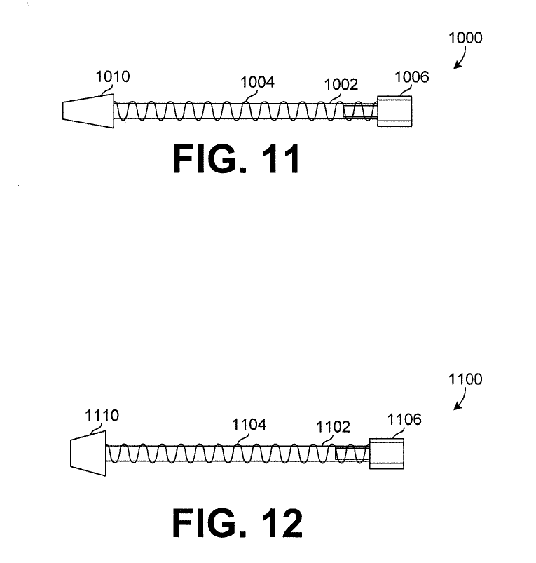

FIG. 11 shows an alternate nozzle 1000. The nozzle 1000 includes tubing 1002 that is wrapped in wire 1004 and a conformable end piece 1010. The wire 1004 wrapped helically about the tubing 1002 allows the tubing 1002 to be flexible and prevents the tubing from over-flexing which could cause kinks. The conformable end piece 1010 features a narrow tapered diameter allowing the end piece 1010 to interface with a smaller drain opening. The conformable end piece 1010 is pressed into the drain opening to seal the nozzle to the drain opening. The tapered nature of the end piece 1010 diameter allows the nozzle to be used on drain openings having a range of diameters. The nozzle can be releasably connected to any of the embodiments of the drain clearing device discussed herein by using the threaded connector 1006.

FIG. 12 shows further alternate nozzle 1100. As with the nozzle 1000 of FIG. 11, the nozzle 1100 includes a wire 1104 wrapped helically about the tube 1102 and a conformable end piece 1110. The conformable end piece 1110 features a wider tapered diameter than the end piece 1010 of the nozzle 1000. The wider tapered diameter allows the end piece 1110 to interface with drains having a range of diameters that are larger than the drain openings the nozzle 1000 could be used with. A threaded connector 1106 can be used to releasably connect the nozzle 1100 to any of the embodiments of drain clearing device discussed herein.

Both of the nozzles 1000 and 1100 include affixed conformable end pieces 1010 and 1110, respectively. The conformable end pieces, 1010 and 1110, are sized to fit standard drain openings. As the end pieces have fixed tapered diameters, there is less material that can interfere with the insertion of the conformable end piece into a drain opening. This style of end piece can be used in tight, confined spaces about the drain opening or with drain openings that have unfavorable approach angles where a more generic end piece would have trouble fitting.

The releasably interconnected elements of the drain clearing device 900 allow it to be manufactured and retailed as a kit. The kit can contain the base device of the gas reservoir 902, valve 904, regulator 906, triggering mechanism 910 and the optional pressure indicator 908. These components can be pre-assembled or individual within the kit in order to save space. The kit can also include a number of pre-selected or customized nozzles that can be sized to fit the drain openings that a user may encounter. Once on-site, the user can assemble or prepare the drain clearing device, and then select and affix the desired nozzle before performing the drain clearing operation. The interchangeable nature of the drain clearing device allows a user to save space while maintaining the flexibility to clear drains having a number of physical dimensions and locations.

Additionally, the other components of the drain clearing device can also be interchanged as needed or desired. Such components include the gas reservoir which can be changed when empty or a different gas is desired, a selection of regulators depending on the pressure required to clear the drain, and different triggering mechanisms.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

1. A drain clearing device, comprising:
a gas reservoir structured to house a gas having a pressure;
a valve in fluid communication with the gas reservoir and structured to allow gas to flow from the gas reservoir;
a triggering mechanism in fluid communication with the gas reservoir and structured to control the release of the gas from the device; and
a nozzle in fluid communication with the gas reservoir and structured to create a seal with a drain.

2. The drain clearing device of claim 1, further comprising a regulator in fluid communication with the gas reservoir and structured to regulate the flow of the gas through the device.

3. The drain clearing device of claim 1, further comprising a pressure indicator structured to communicate an internal pressure of the gas reservoir.

4. The drain clearing device of claim 1, further comprising an extension element disposed between the triggering mechanism and the nozzle, the extension element structured to allow fluid communication between the nozzle and the gas reservoir.

5. The drain clearing device of claim 4, wherein the extension element includes at least one of a rigid, semi-rigid, or flexible material.

6. The drain clearing device of claim 4, wherein the extension element is releasably connected to at least one of the triggering mechanism or the nozzle.

7. The drain clearing device of claim 4, wherein the extension element comprises a wire wrapped helically about the extension element and structured to allow a range of flexing of the extension element.

8. The drain clearing device of claim 1, wherein the nozzle is selected from a plurality of nozzles, the selected nozzle structured to interface with the drain.

9. The drain clearing device of claim 1, wherein the nozzle has a tapered profile comprised of alternating sloped and flat diameters.

10. The drain clearing device of claim 1, wherein the pressurized gas is one of atmospheric air, CO₂, N₂, and NO₂.

11. The drain clearing device of claim of claim 1, wherein the gas reservoir is a self-contained, releasably connected, pre-pressurized gas cartridge.

12. The drain clearing device of claim 1, wherein the pressure is between 80 and 130 psi.

13. A method for clearing a drain, comprising:
selecting a nozzle based on the opening of the drain, the nozzle in fluid communication with a gas reservoir containing a pressurized gas;
placing the nozzle in a drain opening to form a seal between the nozzle and the drain opening; and
releasing at least a portion of the pressurized gas from the gas reservoir through the nozzle.

14. The method of claim 13, wherein the selected nozzle has a tapered profiled comprised of alternating sloped and flat diameters.

15. A drain clearing device, comprising:
a gas reservoir structured to contain a gas having a pressure;
a valve, the valve releasably connected to and in fluid communication with the gas reservoir, the valve structured to control the release of pressurized gas from the gas reservoir;
a regulator releasably connected to and in fluid communication with the valve, the regulator structured to control the flow of pressurized gas from the gas reservoir and through the device;
a trigger mechanism, the trigger mechanism releasably connected to and in fluid communication with the regulator, the trigger mechanism structured to control the release of pressurized gas from the device;
a flexible extension element releasably connected to and in fluid communication with the trigger mechanism; and
a nozzle, the nozzle releasably connected to and in fluid communication with the flexible extension element, the nozzle structured to interface with an opening to form a seal.

16. The drain clearing device of claim 15, wherein the gas is one of atmospheric air, CO₂, N₂, and NO₂.

17. The drain clearing device of claim 16, wherein the pressure is between 80 and 130 psi.
